(19) United States
(12) Patent Application Publication
(10) Pub. No.: US 2017/0223934 A1
(43) Pub. Date: Aug. 10, 2017

(54) AUTOMATED ENCLOSED SYSTEM FOR EGG INCUBATION AND LARVAL GROWTH

(71) Applicant: Mohsen Pakbaz, Sisakht (IR)

(72) Inventor: Mohsen Pakbaz, Sisakht (IR)

(21) Appl. No.: 15/451,333

(22) Filed: Mar. 6, 2017

(30) Foreign Application Priority Data
Mar. 5, 2016 (IR) 13945014000301399

(51) Int. Cl. A01K 61/17; A01K 63/04; C02F 1/32; A01K 63/06

(52) U.S. Cl. CPC A01K 61/17; A01K 63/065; A01K 63/04; A01K 63/042; C02F 1/32; C02F 2001/007

(57) ABSTRACT

An enclosed incubation system for production of trout fish is disclosed. The incubation system includes: an ultraviolet unit to disinfect water prior to entering the system, a disinfecting tank to disinfect water, a plurality of water tanks to supply water, a water heater, a plurality of fish tanks, a plurality of inlet and outlet valves, a plurality of canals, a first and a second aeration pump to aerate the plurality of the fish tanks.

### CROSS REFERNCE TO RELATED APPLICATION

This application claims the benefit of priority to an Iran application serial number 139450140003013993 filed on Mar. 6, 2016, which is incorporated by reference herein in its entirety.

### TECHNICAL FIELD

The present disclosure relates generally to automated aquatic systems and more particularly to an automated enclosed system for egg incubation and larval growth for trout fish production.

### BACKGROUND

In recent years, the world has witnessed an alarming decline in commercial fisheries, the result of overfishing and environmental degradation. According to the Food and Agriculture Organization (FAO) of the United Nations, nearly 70% of the world's commercial marine fisheries species are now fully exploited, overexploited or depleted. Based on anticipated population growth, it is estimated that the world's demand for seafood will double by the year 2025. Therefore, a growing gap is developing between demand and supply of fisheries products, which results in a growing seafood deficit. Even the most favorable estimates project that in the year 2025 the global demand for seafood will be twice as much as the commercial fisheries harvest. The same trend is present in the U.S. Per capita consumption of seafood by Americans increased 25% from 1984 to 1994, and continues to increase. Thus, the United States has become highly dependent on imported seafood. The U.S. is, after Japan, the world's largest importer of seafood. The value of fish imports increased by nearly 80% between 1985 and 1994 to a record level of nearly $12 billion U.S. This has resulted in a trade deficit of $7 billion U.S. for edible seafood, which is, after petroleum, the largest contributor to the U.S. trade deficit among natural products and the largest deficit among all agricultural products.

In many countries including the U.S., fish are grown in either earthen ponds or in floating net pens in the marine coastal environments. Both techniques have an adverse impact on the environment, in some cases resulting in massive degradation of aquatic and marine resources. Moreover, such techniques are far from offering optimal conditions for the desired performances and production. In this context, there are many benefits to developing aquaculture techniques with improved and commercially viable character for high volume production of fish and environmental sustainability.

### SUMMARY

In one general aspect, the instant application describes an enclosed incubation system for production of trout fish comprising. The enclosed incubation system includes a disinfecting tank configured to receive and disinfect water; a plurality of water tanks that are disposed adjacent to one another. Each water tank is in fluid communication with at least one adjacent water tank and the disinfecting tank. The enclosed incubation system also includes a water heater connected to a first water tank of the plurality of the water tanks; and a plurality of fish tanks arranged in a substantially stacked formation. The plurality of fish tanks are disposed adjacent to the water tanks. Each of the plurality of fish tanks has a first water outlet on an upper half of a first end of each of the plurality of the fish tanks and a second water outlet below the first water outlet. The enclosed incubation system also includes a first inlet valve being configured to permit water to travel between at least one water tank of the plurality of water tanks and a fish tank of the plurality of fish tanks and a plurality of canal portions formed along a second end of at least one fish tank of the plurality of the fish tanks. Each of the plurality of fish tanks includes a second inlet valve from among a plurality of second inlet valves connecting each of the plurality of fish tanks to the disinfecting tank. The enclosed incubation system also includes a first aeration pump configured to aerate the plurality of the water tanks; and a second aeration pump configured to aerate the plurality of the fish tanks.

The above general aspect may include one or more of the following features. The enclosed incubation may also include an ultraviolet unit coupled to the incubation system and configured to disinfect water prior entering the incubation system. The plurality of water tanks may serve as sedimentation tanks. The disinfecting tank may be approximately 15 liters. The plurality of water tanks may be approximately 50 liters each. Each of the plurality of fish tanks may be approximately 40 cm*80 cm. Each of the plurality of the fish tanks may be divided by a blade-like plate in half. A sink-hole may be located at the bottom of each of the plurality of the fish tanks to exit a larvae. The water heater may be a gas heater. The water heater may be located inside the first of the plurality of the water tanks.

The first water outlet in each of the plurality of the fish tanks may be open and the second water outlet in each of the plurality of the fish tanks may be closed during an egg incubation period. The first water outlet in each of the plurality of the fish tanks may be closed and the second water outlet in each of the plurality of the fish tanks may be open during a larval growth period. The plurality of the water tanks may have equal volumes. The plurality of the fish tanks are located at an equal distance from each other.

The plurality of the fish tanks have an equal size. The enclosed incubation system may further include a first access door on top of the enclosed aquaculture system to access the water tanks; a second access door on upper front of the enclosed aquaculture system to access the first aeration pump and the second aeration pump and circuitry; a third access door on the lower front of the enclosed aquaculture system to access a lower part of the aquaculture system; and a fourth access door on the right side of the enclosed aquaculture system to access the inlet valves.

### BRIEF DESCRIPTION OF THE DRAWINGS

Features of the subject technology are set forth in the appended claims. However, for purpose of explanation, several implementations of the subject technology are set forth in the following figures.

FIG. 1A illustrates the automated enclosed aquaculture system for egg incubation and larval growth for fish production, and FIG. 1B illustrates a portion of the automated enclosed aquaculture system, according to a preferred implementation of the instant application.

FIG. 2 illustrates the water supply section of the automated enclosed aquaculture system, according an implementation of the instant application.

FIG. 3 illustrates the egg incubation and larval growth section of the automated enclosed aquaculture system, according to one aspect of the resent application.

FIGS. 4A, 4B, and 4C illustrate three implementations of a fish tank for hatching fish eggs and larval growth of the trout fish.

FIGS. 5A and 5B illustrate the back of the automated enclosed aquaculture system for egg incubation and larval growth for fish production, according to one implementation of the present application

FIG. 6 illustrates a door to inspect and access to the water supply section of the automated enclosed aquaculture system for egg incubation and larval growth for fish production, according to one implementation of the present application.

### DETAILED DESCRIPTION

In the following detailed description, various examples are presented to provide a thorough understanding of inventive concepts, and various aspects thereof that are set forth by this disclosure. However, upon reading the present disclosure, it may become apparent to persons of skill that various inventive concepts and aspects thereof may be practiced without one or more details shown in the examples. In other instances, well known procedures, operations and materials have been described at a relatively high-level, without detail, to avoid unnecessarily obscuring description of inventive concepts and aspects thereof.

Typically, a series of treatment processes is used to help maintain water quality in intensive fish farming operations. These steps are often done in order or sometimes in tandem, and support a healthy environment for the fish. For example, after leaving the vessel that holds fish, the water is treated for solids before entering a bio-filter to convert ammonia. Following this treatment, degassing and oxygenation occur, often followed by heating/cooling and sterilization. Each of these processes can be completed by using a variety of different methods and equipment.

In general, the fish farming methods are poorly integrated in respect of the life stages of the fish species of interest and the process conditions associated therewith. Thus, the commercial aquaculture systems developed to date are highly variable in efficiency and output of fish. Such systems are subject to numerous processing and operational deficiencies, including: sub-optimal production of fish, absence of control of process conditions, process instability, susceptibility to environmental pathogens, susceptibility to pollution, loss of stock, and the lack of well-defined optimal conditions for achieving maximal growth and production of the fish species being raised in the aquaculture system. There is therefore a basic need in the art of fish farming for aquaculture systems of improved character that can provide for high performance production of fish species.

Furthermore, oxygenating the system water is important in order to obtain high production densities. Fish require oxygen to metabolize food and grow, as do bacteria communities in the bio-filter. Dissolved oxygen levels can be increased through two methods: aeration and oxygenation. In aeration, air is pumped through an air stone or similar device that creates small bubbles in the water column, which results in a high surface area where oxygen can dissolve into the water. In general, due to slow gas dissolution rates and the high air pressure needed to create small bubbles, this method is considered inefficient and the water is instead oxygenated by pumping in pure oxygen. Various methods are used to ensure that during oxygenation all of the oxygen dissolves into the water column. Careful calculation and consideration must be given to the oxygen demand of a given system.

In addition, all fish species have a preferred temperature above and below which that fish will experience negative health effects and eventually death. For example, warm water species such as Tilapia and Barramundi prefer 24° C. water or warmer, whereas cold water species such as trout and salmon prefer water temperature below 16° C. Temperature also plays an important role in dissolved oxygen concentrations, with higher water temperatures having lower values for dissolved oxygen saturation. Temperature can be controlled using submerged heaters, heat pumps, chillers, and heat exchangers. Sometimes, multiple temperature control devices may be used in concert to keep a system operating at the optimal temperature for maximizing fish production.

As noted above, conventional aquaculture systems and incubators have also typically required significant amounts of human intervention to enable a species of interest to be grown and cultured. Such systems are not “closed,” instead requiring partial water changes and the like. In large systems, significant amounts of water may need to be used and disposed of. An incubation system which is automated and truly closed as disclosed herein would be greatly advantageous.

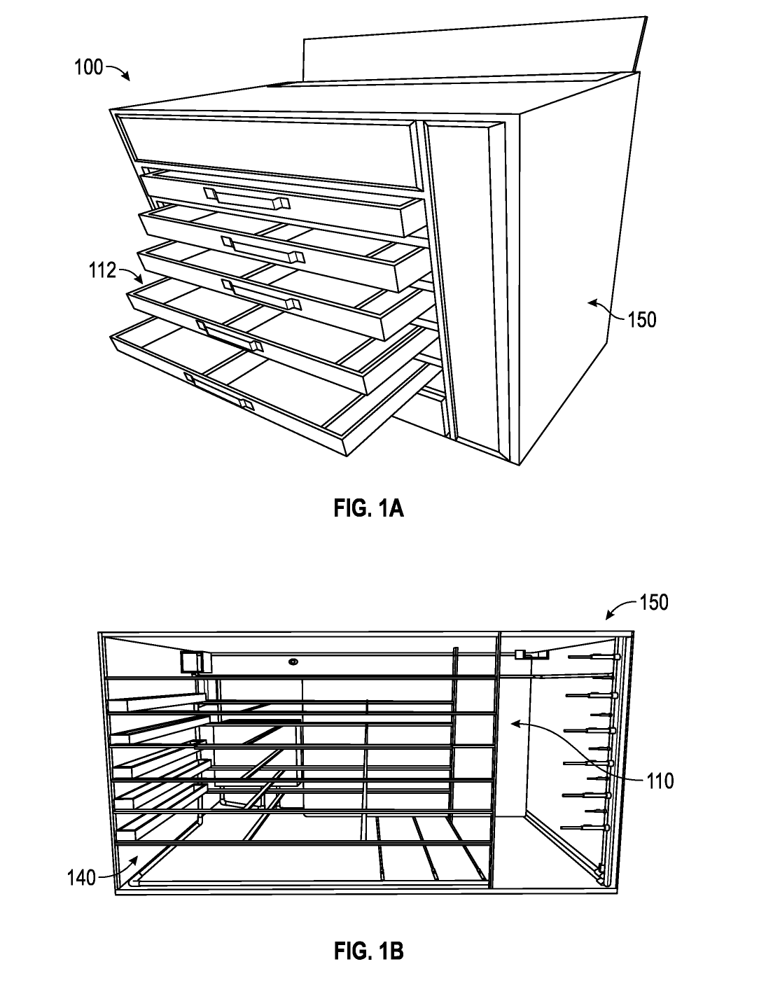

In one general aspect, the instant application describes an automated enclosed aquaculture system for egg incubation and larval growth for trout fish farming. In some implementations, the enclosed system can be a compact portable apparatus which may fit within a small area. In FIGS. 1A and 1B, various components of an automated enclosed aquaculture system for egg incubation and larval growth for fish production are illustrated (“incubation system”) 100. In some implementations, these components can be disposed within a housing. The term “housing” as used throughout this detailed description and in the claims, refers to any housing, enclosure, container or other structure that can be configured to store one or more devices, components and/or systems of a steaming system.

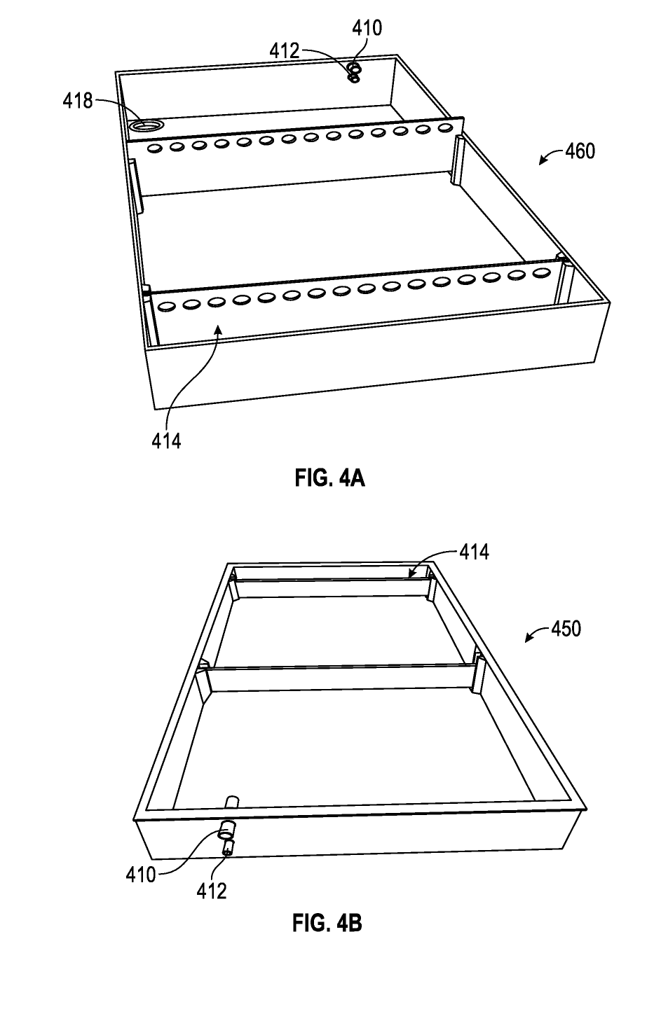

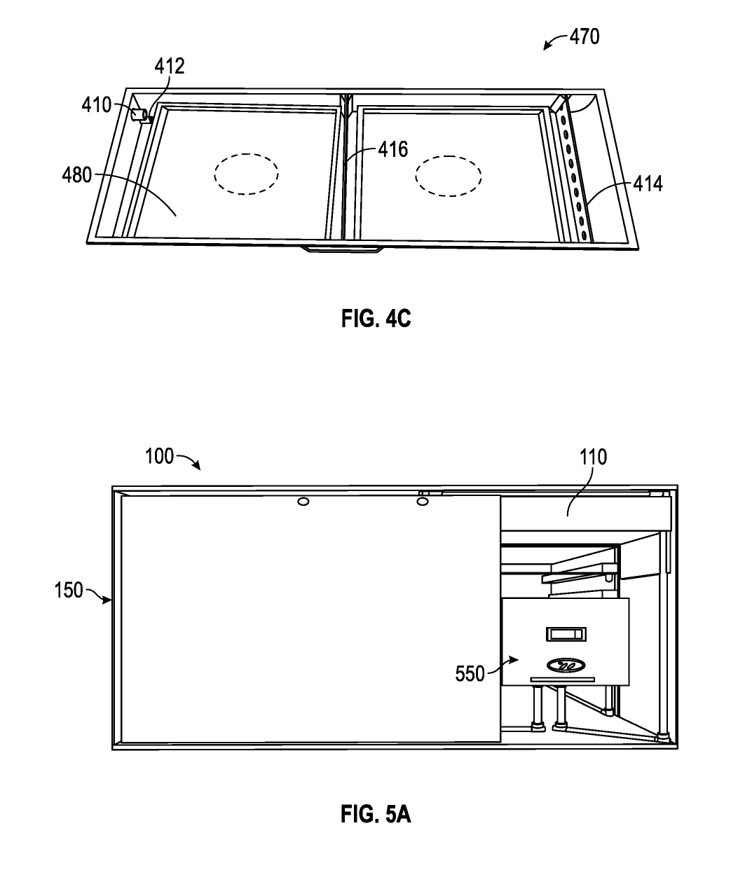

For example, FIG. 1A depicts an exterior view of an implementation of a portable housing (“housing”) 150 for incubation system 100. As used herein, a “portable housing” refers to any housing, enclosure, container or other structure that may be moved from one location to another. Specifically, a portable housing may be any housing that is not required to be permanently secured to a ground surface in order for the steaming system to operate, is not attached to another building, or is capable of being displaced. In different implementations, incubation system 100 may include two sections: a water supply section 110 (see FIG. 1B) and an egg incubation and larval growth section (“growth section”) 112 (see FIG. 1A). Further details regarding growth section 112 will be provided below with respect to FIGS. 3 and 4A-4C.

In order to provide clarity to the reader, in FIG. 1B, some components of growth section have been removed to better illustrate the water supply section 110. It can be seen that in one implementation, water supply section 110 is disposed in a rear portion of housing 150, directly adjacent to a space or cavity 140 configured to receive the removed components comprising the growth section.

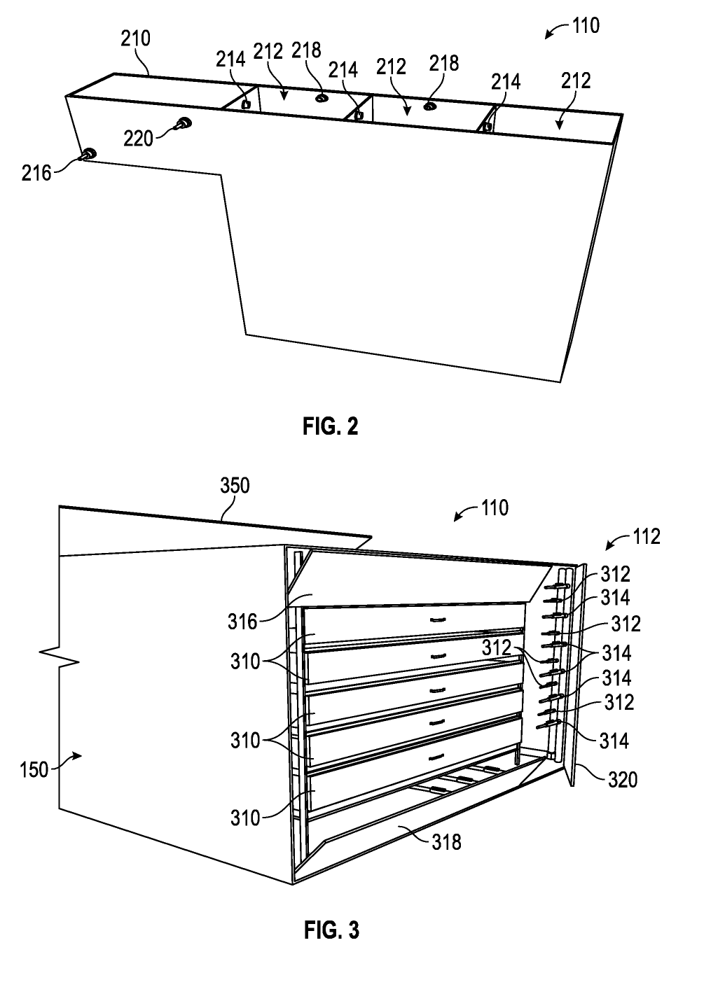

An isolated view of the water supply section 110 is illustrated in FIG. 2. In some implementations, the water supply section 110 may include a disinfecting tank 210, a plurality of water tanks (“water tanks”) 212, a plurality of fittings (“fittings”) 214, a first water inlet (not shown), a first water outlet 216, a plurality of outlets 218, a second water outlet 220, a first aeration pump (not shown), and a water heater (not shown). In FIG. 2, it can be seen that plurality of water tanks 212 can comprise three 50 L water tanks: a first water tank, a second water tank, and a third water tank. Other implementations can include fewer or additional water tanks.

The arrangement of the various portions of water supply section 110 can vary in different implementations. In FIG. 2, disinfecting tank 210 extends distally outward from the remainder of water supply section 110, in a manner similar to that of a ledge. In other words, water supply section 110 includes an L shaped segment, with an open space available between the lower surface of disinfecting tank 210 and the base surface upon which water supply section 110 is disposed. In some implementations, this space can be configured to accommodate other components of the incubation system.

Thus, referring to the water supply section 110 of the incubation system 100, in one implementation, the water may enter the disinfecting tank 210 though the first water inlet at the bottom right of the disinfecting tank 210. The disinfecting tank 210 may be used to disinfect the water. In one preferred example of the present application, the disinfecting tank 210 may be used to disinfect the eggs. In one implementation of the present application, the water may pass through an ultraviolet tank prior to entering the disinfecting tank 210. The ultraviolet tank may be located behind the incubation system 100.

The disinfected water may transfer from the disinfecting tank 210 to the first water tank of the plurality of water tanks 212 through a fitting 214. The first of the plurality of the water tanks 212 may be equipped with a water heater to increase the temperature of the water to the desired temperature, as the ambient temperature may decrease during the nights and winter season. Therefore, the present application may be used for different seasons and different temperatures. The water may continue to transfer between the adjacent water tanks 212 via a plurality of fittings 214. The fittings may be located on a sidewall of each of the plurality of water tanks 212. A first aeration pump may also be used to aerate the water tanks 212. In a preferred example of the present application, the water tanks 212 may be used as sedimentation tanks. Moreover, depending on the egg and larvae load, fewer than all the water tanks 212 may be used for water consumption. Furthermore, in one embodiment, each of the water tanks 212 may be configured to hold an equal volume of water relative to one another. Thus, as shown in FIG. 2, each of the three water tanks 212 are equal-volume water tanks. In some implementations, each of the water tanks 212 may have approximately a 50L capacity. However, in other implementations, one or more water tanks can have a capacity greater than 50L or less than 50L. The water may be transferred from the third water tank of the plurality of the water tanks 212 to the egg incubation and larval growth section (see FIG. 3) via a water outlets at the bottom of the third water tank.

As illustrated in FIG. 3, the growth section 112 of the incubation system 100 may include a plurality of fish tanks (“fish tanks”) 310, a plurality of first inlet valves (“first inlet valves”) 312, a plurality of second inlet valves (“second inlet valves”) 314, and a second aeration pump (not shown). Each of the fish tanks 310 can be configured as a type of container or drawer unit in some implementations. The first inlet valves 312 and second inlet valves 314 may also be seen in the view provided earlier in FIG. 1B.

In one implementation, water can be transferred from the water supply section to the growth section 112. The water enters the growth section 112 through two channels: from the water tanks and/or the disinfecting tank (see FIG. 2). Each of the water tanks are connected to each of the fish tanks 310 through one valve of the first inlet valves 312. The treated water enters the fish tanks 310 at desired temperature from the water tanks. Further, each water tank 310 is connected to the disinfecting tank through one valve of the second inlet valves 314. Through the second inlet valves 314, the disinfected eggs may be transferred to the fish tanks 310 directly from the disinfecting tank. In addition, the second aeration pump (not shown) may be used to aerate the fish tanks 310.

As shown in FIG. 3, five fish tanks 310 may be included in incubation system 100. However, in other implementations, fewer or greater number of fish tanks 310 and/or water tanks can be included or used. Furthermore, in one preferred implementation, two or more of the fish tanks 310 are equal-volume in capacity relative to one another. In one implementation, all of the fish tanks 310 have an equal-volume capacity relative to one another. In some implementations, the dimensions of each of the fish tanks can vary. For example, in one implementation, one or more of the five equal-volume fish tanks 310 may be 40×80 cm in dimension. Moreover, each fish tank 310 may have approximately a 15 L capacity. Equal-volume fish tanks may provide a uniform incubation environment for incubation system. However, it should be understood that in other implementations, the capacity (volume) and/or dimensions of the fish tanks can differ according to the fish type and other requirements of the system.

In addition, as shown in FIG. 3, in some implementations, fish tanks 310 can be arranged in a stacked formation and/or aligned with adjacent fish tanks. In other words, a first fish tank can be disposed directly above a second fish tank, and a second fish tank can be disposed directly above a third fish tank, and so forth. For example, in one implementation, fish tanks 310 can be arranged in a manner similar to a shelving unit or dresser.

As noted earlier, the aquaculture system 100 can be disposed in housing 150 in some implementations. In order to access different sections of the aquaculture system 100, a plurality of doors or panels may be included in the housing 150, according to an aspect of the present application. The various access door may be substantially rectangular in some implementations, though in other implementations, an access door can be any other shape configured for access to various internal portions of the aquaculture system 100. For example, in FIG. 3, a first access door 350 is located along the top surface of the aquaculture system 100. First access door 350 can be used to access the disinfecting tank and the water tanks. In addition, housing 150 can include a second access door 316 along the front or forward-facing surface of the aquaculture system 100. Second access door 316 can provide access to the first aeration pump and the second aeration pump, as well as the internal circuitry. A third access door 318 may be used to access the lower part of the aquaculture system 100. As shown in FIG. 3, the third access door 318 may be located along the lower front surface of the housing of the aquaculture system, and extend along the bottom portion of the housing between the two sidewalls. Furthermore, a fourth access door 320 may be used to access the inlet valves. As shown in FIG. 3, fourth access door located at the right front side of the aquaculture system 100 and be disposed in a vertical orientation between the top and bottom walls of the housing.

In order to provide greater detail to the reader regarding the above referenced fish tanks 310, FIGS. 4A, 4B, and 4C illustrate isolated views of various implementations of a fish tank. Referring to FIGS. 4A, 4B, and 4C, it can be seen that each of the fish tanks may include a third water outlet 410 and a fourth water outlet 412. The third and fourth water outlets may be placed in end of the fish tanks. Water may enter from the second end of the fish tanks. Each water outlet can be connected through a tubing (not shown) with one or more water tanks to allow water to move from the water tanks into the fish tank(s). Furthermore, a fish tank can comprise one or more divider walls 416, which can be inserted or included in the fish tank to form multiple tank compartments or sections. In some implementations, a fish tank may also include a sinkhole 418 and/or a canal portion 414.

Referring to the three implementations depicted in FIGS. 4A-4C, it can be seen that fish tanks may be divided into at least two portions or tank compartments via divider wall 416. In one implementation, the divider wall 416 may divide a fish tank into two equal parts or compartments. However, in other implementations, the divider wall 416 can divide the fish tank into unequally sized compartments. Furthermore, there may be slots or other securing means formed or disposed along the surface of the fish wall that are configured to receive the divider wall 416 and allow for smooth insertion and/or removal of the divider wall as required. In some implementations, there may be multiple divider walls to allow a fish tank to include additional tank compartments.

As noted above, the divider wall 416 may be removed to create larger regions for fish growth, for example when the egg incubation phase is over and the larvae start to grow, at which time the larvae require more space. Egg incubation phase typically require less water. Therefore, to reduce the water consumption during the egg incubation phase, the water level may be changed. The third water outlet 410 may be located on a first end of each fish tank on the side wall, and the fourth water outlet 412 may be located below the third water outlet 412, for example in order to align with other components of the system. During the egg incubation phase, the third water outlet 410 is closed, while the fourth water outlet 412 is open to reduce the water consumption. On the other hand, during the larval growth phase, the third water outlet 410 is open, while the fourth water outlet 412 is closed to increase the water level. Furthermore, in case of excess water, on the secondend of each fish tank, a narrow canal portion 414 may also be formed in the fish tank, and can be used to receive and/or remove the excess water. To remove the larvae from each fish tank, a sinkhole 418 may be located at the bottom of each tank.

Furthermore, it should be understood that a fish tank can vary in different implementations. For example, while FIG. 4A shows a first fish tank 450 with divider walls that include with a series of holes or apertures along the top portion of the divider wall. In some cases, the holes can be used to allow overflow to occur between the compartments. In other cases, the holes can be configured to allow a person's fingers to more easily engage with the divider wall (i.e., to insert or remove the divider wall). In addition, as seen with respect to a third fish tank 470 of FIG. 4C, some fish tanks can include additional components. In FIG. 4C, each compartment further includes a pan 480 with sidewalls. Each pan 480 can be removable in some implementations. For example, the pan can be removed for cleaning, filling, emptying, cataloguing, replacement, observation, or other system needs. The pan can then be readily re-inserted into the fish tank. By facilitating access to the compartment contents, the use of a pan can improve the longevity and usability of the fish tanks.

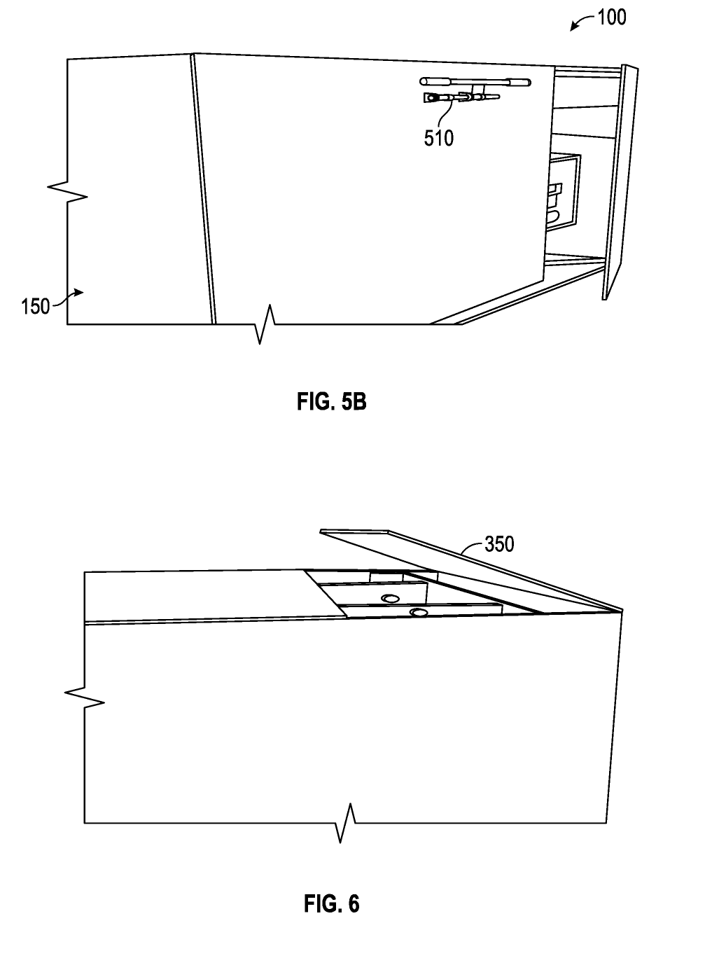

Referring now to FIGS. 5A & 5B, a rear-side view of the aquaculture system 100 is depicted according to one implementation of the present application. FIG. 5A shows an example of a water heater 550 used to provide the water with desired temperature to the water tanks. Water heater 550 is configured to fit within the space provided by the L-shaped water supply section 110, as noted earlier. FIG. 5B illustrates a UV unit 510 to further disinfect the water in the fish tanks.

FIG. 6 further illustrates a side view of access door 350 (see FIG. 3) to allow access to the water tanks and disinfecting tank section of the incubation system.

Thus, as disclosed herein, in some implementations, an enclosed incubation system for production of trout fish can comprise: (a) a disinfecting tank that is configured to disinfect the water prior to entering the system; (b) a plurality of water tanks, wherein the water tanks are connected in series via fittings; (c) a water heater connected to the first water tank; and (d) a plurality of equal-volume fish tanks located below the water tanks and on top of each other at equal distances. In some implementations, the water is supplied from one of the water tanks (such as the last or final water tank) to the fish tanks through a tubing. Furthermore, in one implementation each fish tank can have a first water outlet on the upper half of the first end of the side-wall of the fish tank as well as a second water outlet below the first water outlet, located on the lower half of the first end of the side-wall of the fish tank. One or more water outlets can be configured to egress of any excess water. In other implementations, the system can further include: (e) a plurality of inlet valves connecting each fish tank to the water tanks; (f) a plurality of canal portions attached to the second end of each fish tank that can allow the exit of any excess water; (g) a plurality of inlet valves connecting each fish tank to the disinfecting tank; (h) a first aeration pump configured to aerate the water tanks; (i) a second aeration pump configured to aerate the fish tanks; (j) a first access door on top of the enclosed aquaculture system to access the water tanks; (k) a second access door to allow access to the first aeration pump and the second aeration pump and the circuitry; (1) a third access door on the lower front of the enclosed aquaculture system to access the outlet valves; and/or (m) a fourth access door on a side of the front of the housing of the enclosed incubation system to access the inlet valves. In another implementation a pump may be used to circulate the water.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. An enclosed incubation system for production of trout fish comprising:
a disinfecting tank, configured to receive and disinfect water;
a plurality of water tanks that are disposed adjacent to one another, wherein each water tank is in fluid communication with at least one adjacent water tank and the disinfecting tank;
a water heater connected to a first water tank of the plurality of the water tanks;
a plurality of fish tanks arranged in a substantially stacked formation, the plurality of fish tanks being disposed adjacent to the water tanks;
wherein each of the plurality of fish tanks has a first water outlet on an upper half of a first end of each of the plurality of the fish tanks and a second water outlet below the first water outlet;
a first inlet valve being configured to permit water to travel between at least one water tank of the plurality of water tanks and a fish tank of the plurality of fish tanks;
a plurality of canal portions formed along a second end of at least one fish tank of the plurality of the fish tanks;
each of the plurality of fish tanks including a second inlet valve from among a plurality of second inlet valves connecting each of the plurality of fish tanks to the disinfecting tank;
a first aeration pump configured to aerate the plurality of the water tanks; and
a second aeration pump configured to aerate the plurality of the fish tanks.

2. The system of claim 1, further comprising an ultraviolet unit coupled to the incubation system and configured to disinfect water prior entering the incubation system.

3. The system of claim 1, wherein the plurality of water tanks serve as sedimentation tanks.

4. The system of claim 1, wherein the disinfecting tank is approximately 15 liters.

5. The system of claim 1, wherein the plurality of water tanks are approximately 50 liters each.

6. The system of claim 1, wherein each of the plurality of fish tanks is approximately 40 cm*80 cm.

7. The system of claim 1, wherein each of the plurality of the fish tanks is divided by a blade-like plate in half

8. The system of claim 1, wherein a sink-hole is located at the bottom of each of the plurality of the fish tanks to exit a larvae.

9. The system of claim 1, wherein the water heater is a gas heater.

10. The system of claim 1, wherein the water heater is located inside the first of the plurality of the water tanks.

11. The system of claim 1, wherein the first water outlet in each of the plurality of the fish tanks is open and the second water outlet in each of the plurality of the fish tanks is closed during an egg incubation period.

12. The system of claim 1, wherein the first water outlet in each of the plurality of the fish tanks is closed and the second water outlet in each of the plurality of the fish tanks is open during a larval growth period.

13. The system of claim 1, wherein the plurality of the water tanks have equal volumes.

14. The system of claim 1, wherein the plurality of the fish tanks are located at equal distance from each other.

15. The system of claim 1, wherein the plurality of the fish tanks have an equal size.

16. The system of claim 1, further comprising:
a first access door on top of the enclosed aquaculture system to access the water tanks;
a second access door on upper front of the enclosed aquaculture system to access the first aeration pump and the second aeration pump and circuitry;
a third access door on the lower front of the enclosed aquaculture system to access a lower part of the aquaculture system; and
a fourth access door on the right side of the enclosed aquaculture system to access the inlet valves.
